(19) United States
(12) Patent Application Publication
(10) Pub. No.: US 2017/0016567 A1
(43) Pub. Date: Jan. 19, 2017

(54) Multilayered Film

(71) Applicant: Buergofol GmbH, Siegenburg (DE)

(72) Inventors: Kurt Stark, Neuhaus a.d. Pegnitz (DE); Gregor Schleicher, Ingolstadt (DE); Abdel-Kader Boutrid, Siegenburg (DE)

(21) Appl. No.: 15/280,146

(22) Filed: Sep. 29, 2016

Related U.S. Application Data
(62) Division of application No. 14/101,809, filed on Dec. 10, 2013.

(30) Foreign Application Priority Data
Dec. 10, 2012 (DE) 10 2012 112 024.2
Jan. 11, 2013 (DE) 10 2013 100 272.2

(51) Int. Cl. F16L 55/165; B32B 27/08; B32B 27/30; F16L 55/18; B32B 27/34; B32B 27/40; B32B 7/12; B32B 1/08; B32B 27/32

(52) U.S. Cl. CPC F16L 55/1656; B32B 1/08; B32B 27/08; B32B 27/308; B32B 27/327; B32B 27/34; B32B 27/40; B32B 7/12; F16L 55/18; B32B 2250/24; B32B 2274/00; B32B 2307/51; B32B 2307/536; B32B 2307/538; B32B 2307/7265; B32B 2597/00; B32B 2270/00

(57) ABSTRACT

A multilayered film is provided, especially in form of a tubular film for use as preliner in trenchless sewage pipe renovation that uses the pipe lining process. The multilayered film has at least one layer (a), which contains at least a homo- or co-polyamide with a proportional weight expressed in percent of more than 25% by weight, preferably as external layer, as well as by at least one layer (b) containing at least one thermoplastic, if need be modified, olefin homo- or copolymer and/or by at least one layer (c) containing at least one thermoplastic elastomer (TPE). Various uses of the multilayered film according to the invention are suggested as well.

### RELATED APPLICATIONS

The present application is a Divisional Application of U.S. application Ser. No. 14/101,809, filed Dec. 10, 2013, which claims priority to German Application No. 10 2012 112 024.2, filed Dec. 10, 2012, and German Application No. 10 2013 100 272.2, filed Jan. 11, 2013.

### FIELD OF THE INVENTION

The invention refers to a multilayered film, particularly a multilayered film shaped like a tubular film for use as preliner for trenchless sewage pipe renovation done with the tube lining process.

### BACKGROUND

The areas of application for films keep expanding. Among the areas of application, in which films with olefin homo- or copolymers are used, for example, is the tube lining process for trenchless sewage pipe renovation, in which a pipe liner (also known as insertion tube or just liner) in the glass fiber pipe liner system with UV- or steam curing has typically an inner and outer hose. Between them, the glass fiber carrier material impregnated with reactive plastic resin is introduced. Examples of reactive plastic resins being used are commercially available UP resins (polyester and unsaturated polyester resins), VE resins (vinyl ester resins) or EP resins (epoxy resins). The curing of the resins is done in the case of the UP or VE resins with the help of photoinitiators, for example, but can also be done with heat.

The insertion tube or pipe liner is inflated inside the pipe until it adheres to an external wall so the resin can subsequently be cured, for example, with UV light from a light source being pulled slowly through the pipe. At the end, the inner film of the insertion tube is peeled off and removed. The layer with the carrier material is then exposed to the substances that will flow through the pipe.

Often, the pipe liner—especially in the synthetic fiber pipe liner system with warm water or steam curing—does not make direct contact with the pipe's inner wall. Rather, a preliner (also known as preliner film), i.e. a thick-walled film lining the pipe completely, knowingly made of high-density polyethylene (HDPE), is introduced into the pipe to be renovated and placed tightly against the pipe's inner wall. Afterwards, the pipe liner is drawn (drawing-in process) or inverted (inversion process) into the pipe. The preliner prevents, for example, the plastic resin of the pipe liner from adhering to the pipe wall and dirt and water from making contact with the insufficiently cured resin. Furthermore, the preliner film also prevents the resin from leaking out of the sewage pipe renovation system and contaminating the soil and ground water. The preliner film also protects the feeds from penetrating excess resin so no resin plugs and obstructions can form.

In the drawing-in process, a preliner can also have a similar function as known sliding films for the pipe liner to be drawn in. In this case, the low coefficient of friction between the sliding film and the external film of the pipe liner is essential. As a result of this, the insertion tube or pipe liner is not damaged by the inner wall of the pipe or objects inside the pipe when it is inserted into it. On the other hand, the friction between pipe liner and sliding film is very low and facilitates an insertion of the pipe liner.

A known preliner film that is very frequently used is known by the brand name of Valeron®. The extremely large mechanical stability of this film results from the cross-linking of two stretched HDPE layers running perpendicularly to one another. The stretching makes the film lose its elasticity and as a result of that, it acquires better tear resistance. The two transversally running layers ensure that the film will be equally resistant in all directions and particularly highly tear and puncture resistant. In addition, a single hole or tear that occurs will not keep expanding owing to the structure of the layer, because reduced film elasticity also results in high puncture resistance.

One disadvantage of the Valeron HDPE film mentioned above often used as preliner is that it cannot be easily turned inside out during the inversion procedure because of its very high inherent stiffness. Moreover, the Valeron film is not available in tubular shape owing to the way it is manufactured, so it must be sealed. However, since the film layers are oriented and stretched, the film cannot be sealed so easily. For this reason, it is necessary but undesirable to use a thermally-activated adhesive (e.g. hot melt) to seal the Valeron film. When doing so, the film overlaps the surface area to be sealed by about 3 to 5 cm, so that the seam or overlapping of the film in this location creates many problems during inversion. The disadvantage of such sealing lies not just in the additional and costly production step but particularly in the risk that the sealing seam will be porous. Therefore, if the sealing is incomplete, water can penetrate through the preliner film from outside and greatly interfere with the curing of the resin. Another disadvantage of the Valeron film is its high affinity to the resins used and this manifests itself in clear resin adherence. This makes it very difficult to invert the pipe liner in the synthetic fiber pipe liner system, for example, in which the resin-impregnated side makes contact with the preliner. Finally, the Valeron film exerts virtually no barrier effect against the monomers and oils used in the resin. Consequently, a migration of noxious substances to the groundwater cannot be prevented.

### SUMMARY OF THE INVENTION

It is a task of this invention to make a film available that will comply with the high demands made on it with regard to mechanical stability with simultaneous high flexibility. It should also be possible to offer such a seamless film, preferably in tubular form, so a seam-shaped predetermined breaking point can be prevented. Here, the goal is to limit as much as possible the film's affinity to the resins used and in particular its adherence to them, especially when used as preliner. Apart from that, a film that is a very good barrier against monomers and oils should be made available. Additional objects and advantages of the invention will be set forth in part in the following description, or may be obvious from the description, or may be learned through practice of the invention.

The film according to the invention has at least one layer (a)—preferably forming one of the film's outer layers—that contains at least a homo- or copolyamide (hereinafter abbreviated as PA) in a proportional weight expressed in percent that exceeds 25% by weight. Additionally, the film according to the invention has either at least one layer (b) that contains at least one thermoplastic, if need be modified, olefin homo- or copolymer, and/or it has at least one layer (c) that contains at least one thermoplastic elastomer.

The advantages of the invention can be seen especially in the fact that films according to the invention have good mechanical properties such as sturdiness, resistance and puncture resistance with relatively low inherent stiffness. Non-sealed tubular films according to the invention that can be turned inside out very well during the inversion procedure in trenchless sewage pipe renovation, for example, and that are also highly leak-proof against water penetration or monomer leakage from the resin of an insertion tube or pipe liner can also be made. The films according to the invention boast an overall outstanding barrier against monomers and oils and this significantly limits adherence to the resin.

Within the meaning of this invention, the term “tubular film” is a seamless, multilayered film manufactured by (co-)extrusion, preferably by blown film (co-)extrusion.

The multilayered film according to the invention contains at least one polyamide layer having more than 25% by weight. It can be a homo- and/or copolyamide or mixtures of various polyamides.

Suitable homo- or copolyamides are preferably selected from the group of thermoplastic aliphatic, partially aromatic or aromatic homo- or copolyamides. These homo- or copolyamides can be manufactured from diamines, such as aliphatic diamines having 2-20 carbon atoms, especially hexamethylene diamine and/or aromatic diamines having 6-10 carbon atoms, especially p-phenylenediamines, and from aliphatic or aromatic dicarboxylic acids having 6-20 carbon atoms such as adipic acid, terephthalic acid or isoterephthalic acid, for example. Furthermore, homo- or copolyamides can be made from lactams having 4-20 carbon atoms, such as ε-caprolactam, for example. Polyamides that can be used according to the invention are preferably PA 6, PA 666, PA 12, PA 11, PA 66, PA 610, PA 612, PA 6I, PA 6T or corresponding copolymers or mixtures from at least two of the mentioned polyamides.

Preferably, the at least one layer (a) of the film according to the invention contains more than 50% by weight, preferably more than 75% by weight, preferably more than 95% by weight and very preferably largely or approximately (i.e. almost or fully) 100% by weight of homo- or copolyamide.

If the film according to the invention has at least one layer (b), then this layer (b) contains preferably more than 20% by weight, especially preferably more than 40% by weight and up to 100% by weight of thermoplastic olefin homo- or copolymer.

Within the meaning of this invention, olefin homo- or copolymers are thermoplastic polymers of α,β-unsaturated olefins having two to six carbon atoms, such as polyethylene (PE, especially LDPE or HDPE), polypropylene (PP), polybutylene (PB), polyisobutylene (PI) or mixtures from at least two of the mentioned polymers, for example. “LDPE” is low density polyethylene that has a density in the range of 0.86-0.93 g/cm³ and is characterized by a high degree of molecular branching. “HDPE” is high density polyethylene whose molecular chains only have few branches and its density can lie between 0.94 and 0.97 g/cm³.

The olefin homo- or copolymer is preferably polyethylene (PE), preferentially used in form of high density polyethylene (HDPE), but LDPE and/or LLDPE (linear low density polyethylene) can also be advantageously used. Also suitable are polyolefins, particularly polyethylenes polymerized with metallocen catalysts (mPE), such as mLDPE (metallocen LDPE) and mLLDPE (metallocen LLDPE). Polyethylene is classified into different categories, mainly with regard to its density and branching. Its mechanical properties depend considerably on variables such as the length and type of branching, crystalline structure and molecular weight. The most widely sold polyethylenes are HDPE, LLDPE and LDPE. Specifically, the order looks like this:
Ultra high molecular weight polyethylene (UHMWPE)
Ultra low molecular weight polyethylene (ULMWPE or PE-WAX)
High molecular weight polyethylene (HMWPE)
High density polyethylene (HDPE)
High density cross-linked polyethylene (HDXLPE)
Cross-linked polyethylene (PEX or XLPE)
Medium density polyethylene (MDPE)
Linear low density polyethylene (LLDPE)
Low density polyethylene (LDPE)
Very low density polyethylene (VLDPE)
Chlorinated polyethylene (CPE)
   VLDPE (very low density polyethylene) is defined by a density range from 0.880 to 0.915 g/cm³. It is largely a linear polymer with a high proportion of short side chains, typically manufactured by linear copolymerization of ethylene with short-chained alpha olefins (e.g. 1-butene, 1-hexene, and 1-octene). VLDPE is manufactured very frequently using metallocen catalysts because they allow the incorporation of more co-monomers.

In accordance with another advantageous alternative, polypropylene (PP) is used as olefin homo- or copolymer.

Mixtures from various olefin homo- or copolymers are by all means possible in the least one layer (b) mentioned, including the ones listed above.

If the film according to the invention has at least one layer (c), then this at least one layer (c) will have preferably more than 20% by weight, especially preferably more than 40% by weight and up to 100% by weight of a thermoplastic elastomer (TPE).

If the film according to the invention has at least one layer (c), then this at least one layer (c) will contain as thermoplastic elastomer (TPE) in accordance with a preferred embodiment, thermoplastic polyurethane (TPU), i.e. a thermoplastic elastomer made of urethane (also known as TPE-U). Examples of it are Desmopan, Texin and Utechllan made by Bayer. Other examples are the products available under the trade names Elastollan, Estane, Morthane, Pellethane, Pearlthane, Skythane or Tecoflex.

Other TPE substances can be advantageously used as well, in which case the following groups are differentiated in addition to TPU and TPE-U:
TPE-O or TPO=Olefin-based thermoplastic elastomers, mostly PP/EPDM, e.g. Santoprene made by AES/Monsanto;
TPE-V or TPV=Olefin-based cross-linked thermoplastic elastomers, mostly PP/EPDM, e.g. Sarlink made by Teknor Apex, Forprene made by SoFter;
TPE-E or TPC=Thermoplastic polyester elastomers/thermoplastic copolyesters, e.g. Hytrel made by DuPont or Riteflex made by Ticona;
TPE-S or TPS=Styrene block copolymers (SBS, SEBS, SEPS, SEEPS and MBS), e.g. Styroflex made by BASF, Septon made by Kuraray or Thermolast made by Kraiburq TPE;
TPE-A or TPA=Thermoplastic copolyamides, e.g. PEBAX made by Arkema.

TPE silicon, made by Wacker and available under the trade name Geniomer, can also be used. Geniomer® is a copolymer made of polydimethylsiloxane and urea and combines the good processing properties of an organic thermoplast with some typical silicone properties. Thus, Geniomer® has a property profile that so far could not be manufactured in this way neither with thermoplasts nor with silicones.

The TPE layer can be specially structured as every one of the three layers (1), (2) and (3) described in EP 1 145 847 A1.

Preferably, the film according to the invention has at least one additional layer executed as adhesive promoter layer (d) (abbreviated AP). This adhesive promoter layer (d) can—depending on the presence of the different layers and on the embodiment—be arranged between two layers (a), between one layer (a) and one layer (b), between two layers (b), between one layer (a) and one layer (c), between one layer (b) and one layer (c), or between two layers (c).

To manufacture the adhesive promoter layer(s) mentioned above, conventional adhesive promoters can be used. Preferably, the adhesive promoter layer(s) is/are made independently from one another of at least one modified thermoplastic polymer, preferably of at least one modified olefin homo- or copolymer. The same olefin homo- or copolymers mentioned above can be used as olefin homo- or copolymers for this, only modified. Especially preferably, the adhesive promoter layer(s) is/are made independently of one another from at least one modified ethylene homo- or copolymer and/or at least one modified propylene homo- or copolymer modified with at least one organic acid or at least one preferably cyclical organic acid anhydride, preferably with maleic anhydride. Even ethylene vinyl acetate, ethylene vinyl alcohol (EVOH) and ethylene (meth)acrylate copolymers, in modified or non-modified form, are ideally suited to be adhesive promoters.

The adhesive promoter layer(s) of the multilayered film according to the invention has/have preferably, independently from one another, a layer thickness of 1 μm to 30 μm, very preferably from 2 μm to 20 μm.

Advantageous layer structures have 3, 5 or even more layers. Exemplary layer sequences are PE/AP/PA or PE/AP/PA/AP/PE or PE/AP/PA/AP/PA.

In an advantageous embodiment of the film according to the invention, both external layers are executed as layer (a), in which case these two external layers consequently contain in each case at least one homo- or copolyamide with a proportional weight expressed in percent exceeding 25% by weight.

It is especially preferable if the polymers in the film are cross-linked by irradiation with beta or gamma rays. Irradiation cross-linking can impart the plastics typically used with the mechanical, thermal and chemical properties of high-performance plastics. The beta or gamma rays used here trigger cross-linking reactions in the polymers. Cross-linking is possible with olefin homo- or copolymers, homo- or copolyamides and also with thermoplastic elastomers. Irradiation cross-linking is easy, economical and flexible. The acceleration voltage can be between 25 and 25 kV, with an intensity between 5 and 500 kGy. Penetration depth is at least 1 μm, so the entire thickness of films and composite films can be penetrated.

Here, irradiation cross-linking between polymers can be done within one layer and/or between polymers of two adjacent layers, which leads to a stronger lamination between these layers.

Cross-linking of films by means of electron irradiation ((β⁻ rays), a well known technique, has been described, for example, in the article “Electron Beam Technology for Converting Applications” by Stephen C. Lapin, Radtech Report; 23, 5; S. 44-47; 2009. Various kinds of information about irradiation cross-linking have also been published in www.bgs.eu/strahlenvernetzung.html by BGS Beta-Gamma-Service GmbH & Co. KG and in www.ebeam.com/markets.php?.section=cross by the Energy Sciences Inc. Co. of Wilmington, Mass., USA. The content of these documents is explicitly included in this disclosure.

According to an advantageous embodiment, the film according to the invention has a thickness of 20 to 2000 μm, preferably of 40 to 1000 μm, very preferably of 60 to 400 μm and especially of 80 to 250 μm.

According to an advantageous embodiment, the at least one layer (b) of the film according to the invention contains an olefin homo- or copolymer and/or a layer (d) intended as adhesive promoter layer with at least one ethylene (meth)acrylate copolymer in functionalized or non-functionalized form. The proportional weight expressed in percent of the at least one ethylene (meth)acrylate co-polymer lies in this case preferably in the range from 0.1 to 100% and is preferably at least 30% by weight. As a result of this, even better elasticity until the film splices or bursts can be achieved.

Preferably, the film according to the invention contains—depending on the specific application—one or several of the following substances in at least one of the film layers: polystyrene (PS); polyhalogenides such as PVC and/or polyvinylidene chloride (PVdC); ethylene vinyl alcohol copolymer (EVOH), polyvinyl alcohol (PVOH or PVAL), adhesive promoter, ethylene vinyl acetate (EVAc); one or several ionomers; one or several poly (meth)acrylates; poly (meth)acrylates containing ethylene, polyvinyl acetate (PVAc); polycarbonate (PC); polyacryl nitrile (PAN); additional polyesters such as polybutylene terephthalate (PBT), polyethylene naphthalate (PEN), polylactic acid (PLA) and/or polyhydroxyalkanoate (PHA); one or several ethylene acrylic acid copolymers (EAA); polyvinyl butyral (PVB); polyvinyl acetale; cellulose acetate (CA); cellulose aceto butyrate (CAB); polysaccharides; starch; cyclic olefin copolymer (COC).

To improve film properties, the following substances or additives can be used in one or several layers during the course of the extrusion: Some of the additives that can be added are, for example, adhesive promoters, functionalized polymers such as EVOH, optical brighteners, thermal stabilizers, lubricants, antioxidants, oxygen scavengers, separators (e.g. silica particles, SAS), slip-/anti-blocking agents, dyes, pigments, foaming agents, antistatic agents, process aids, lubricating agents, flame retardants, flame suppressants, impact modifiers, impact resistance enhancers, anti-hydrolysis agents, UV absorbers, UV protection agents, stabilizers, antifogging additives, waxes, wax additives, release agents, sealing or peeling additives, nucleation agents, compatibilizers, flow agents, flow improvers, melt strength enhancers, molecular weight enhancers, cross-linking agents or softeners.

The films according to the invention can be manufactured in various ways. A preferred manufacturing method uses extrusion or co-extrusion, for example through blowing extrusion or cast extrusion. The favorite is the manufacturing as tubular blowing film.

Preferably, the film according to the invention is not oriented. Moreover, it is preferably capable of being sealed although—as tubular film—it is preferred not to have a sealing seam.

The film according to the invention shaped like a tubular film without sealing seam is advantageously used in pipe renovation that uses the pipe lining technique. When the latter is used, it is especially used as so-called preliner for drawing in or inversion (turning it inside out) into the pipe laid underground, preferably a sewage pipe, to be renovated and then placed tightly against the inner wall of this pipe. Afterwards, a pipe liner with a curable carrier material is pulled so it slides through the preliner laid in the pipe. Alternately, the pipe liner is inverted in the preliner. Outstanding mechanical sturdiness coupled with high flexibility or elasticity, a very high barrier against monomers and oils, low resin adherence and high water resistance thanks to its execution as tubular film without sealing seam give the film according to the invention considerable advantages compared to the known LDPE or HDPE films used to date as preliners, such as the Valeron film mentioned above, for example.

In addition, all the variants of the film according to the invention can be considered for trenchless sewage pipe renovation. In other words, they can be advantageously used as sliding film, reinforced or calibration hose or as the inner tube film of a pipe liner—preferably pre-treated with irradiation cross-linking. A reinforced tube or hose is used for bridging purposes when the inversion drum cannot be placed directly in front of the opening of the pipe to be renovated. In this way, the pipe is not exposed in any place. This need can also become necessary at the end of the reach in order to support the emerging liner. Thus, the reinforced hose replaces the sewage pipe lying outside and offers a corresponding counter pressure for the pipe liner in the exposed places.

The function of a calibration hose corresponds largely to the one of an inner tube film in the UV-/light-curing glass fiber liner system and is arranged in a pipe liner in the same way as an inner tube film. Often, the outer side of a calibration hose (i.e. when used towards the pipe's inner wall) is linked with a fleece or felt. When a calibration hose is used, an inner tube film can be dispensed with. In this case, when the film according to the invention is used as calibration hose, resin can be applied on both sides. Preferably, the resin makes contact with the film in form of a resin-impregnated carrier, which can be, for example, glass fibers or synthetic fiber felts. Then, the layer(s) of the film according to the invention that can be activated make contact with the resin or a resin-impregnated carrier material (such as fleece, felt or fabric, etc.) to obtain a “pipe-in-pipe” system. When the calibration hose is used, the sequence can then be, for example, as follows: Pipe wall outside, if necessary preliner film, then external film of the pipe liner or coating, then synthetic fibers with resin (carriers, constitute the outer pipe), then synthetic fibers with, if need be, resin plus coating or film (constitute the calibration hose as inner pipe). By filling the calibration hose from the inside with water, pressurized air, etc., the synthetic felt liner having the carrier is positioned in the pipe to be renovated.

An additionally assembled sliding film is frequently used to protect the glass fiber reinforced plastic pipe liner from damage during its insertion and to minimize friction.

Possible application techniques in the insertion process mentioned above are both the turning inside out of the pipe liner and also its drawing in as well as the curing of the pipe liner's resins with heat or UV radiation. In this invention, the term “UV radiation” is understood to be electromagnetic radiation having a wavelength range from 200 to 400 nm. In a certain embodiment of the multilayered film according to the invention for use as inner tube film of a pipe liner, it is at least partially transparent for UV radiation, preferably at least 80%, very preferably at least 90%. If the tubular film according to the invention is executed as inner tube film, then this film has been preferably treated with the irradiation cross-linking described above in order to further improve its mechanical and thermal properties.

The invention refers equally to a tube lining system that comprises a preliner or a sliding film that preferably has the structure of multilayered film according to the invention, and a pipe liner, in which case the latter comprises an inner tube film shaped like a multilayered film according to the invention, preferably cross-linked with beta or gamma radiation, an outer film executed as tubular film that advantageously absorbs and/or reflects UV radiation and is intended for being placed tightly against a preliner or sliding film, as well as a carrier material (e.g. glass fiber fabric, felt, fleece, textiles) arranged between these two tubular films and impregnated with reactive plastic resin that forms the renovated inner sewage pipe after curing. Certain designs allow the inner tube film according to the invention to be peeled off after the resin has been cured. The preliner or sliding film is left in the renovated pipe. According to an advantageous embodiment, the inner tube film (preferably pre-treated with irradiation cross-linking) has, on the one hand, the same layer structure according to the invention as the preliner or sliding film, on the other hand.

Alternate uses of the film according to the invention are as packaging material for food or for the so-called non-food sector, as external sheathing, outer cover for building sections, as bag-in-box film, as membrane film, as safety goggles film, solar modules or airbags, as adhesive film, tape or band, for enveloping cables, in protective suits, in textiles and apparel, as decorative film for wood, natural fiber and plastic composite material laminates, as separating and protective film in the prepreg sector (pre-impregnated fibers), as protective film, for signs as well as for medical applications such as patches, for hygiene articles such as diapers, for displays or as insulating material. Even with these films, it is preferable to irradiate in order to promote a cross-linking of the polymers in one or several layers and/or between at least two layers.

The film according to the invention can also be foamed or contain at least one foamed layer.

Furthermore, a powder or talc can be applied to the surface film. Talcum powder is preferably used.

In the context described above, it must likewise be pointed out that the friction value of the preliner according to the invention should be preferably small compared to the outer film of the insertion tube (pipe liner) being inserted into the pipe to be renovated with the help of the sliding film or preliner. In this respect, according to an advantageous embodiment, a lowering of the coefficient of friction (COF) can be achieved with wax additives such as ethylene-bis-stearamide (EBS), erucic acid amide (EAA), etc. and release agents. These wax additives or release agents are preferably applied on the surface of the sliding film that faces the external film of the pipe liner.

Extrusion coating and a glazing roller process are also possible. In addition, lamination techniques can be used.

Moreover, it is advantageously possible to laminate the film according to the invention with a non-woven material, textile, needle felt, synthetic fibers or fleece, in which case thermal lamination or adhesive lamination can be used. Such preliner lamination can facilitate an even better bonding of the pipe liner inverted in the preliner film, for example.

If the film according to the invention is executed as preliner, a PE base for the laminating foil is preferred because during the course of the exothermic curing of the reactive resins that serve as carrier material in the pipe liner, a linkup of the PE laminating foil to the (cured) pipe liner can be accomplished by increasing the temperature owing to the initiation with UV light (or hot water or water vapor, for example, as alternative sources for curing the resin). As a result of this, the stability of the pipe liner can once again be significantly strengthened, especially after its curing, and this contributes to improve the strength of the sewage pipe renovated with the pipe liner.

The film according to the invention can also be subsequently stretched or embossed. An imprinting is also possible.

The structuring of the film surface can also be done on a correspondingly structured roller through casting.

According to an advantageous embodiment, the film surface is roughened by adding separators (anti-blocking agents), for example by preparing a batch with coarser particles having a diameter of 0.01 to 10 μm. To do this, silica particles are used in at least one of the external layers, for example, to prevent the sliding film or preliner to adhere to the insertion tube or pipe liner.

Further processing options consist in bringing together the film according to the invention with a unidirectional weave or knitted fabric, e.g. a plastic net or a grid. Alternately, this grid, unidirectional weave or knitted fabric can be introduced into the film for the purpose of strengthening it further.

### DESCRIPTION OF THE PREFERRED EMBODIMENTS

### Application Examples

The following examples and comparative examples serve to explain the invention, but they should not be interpreted restrictively.

### I. Chemical Characterization of the Used Raw Materials

Commercially available polyamides of the following companies (with the corresponding brand names in parentheses) can be used as polyamides (PA) for the at least one layer (a): BASF (Ultramid), Lanxess (Durethan), DuPont (Zytel), DSM Engineering Plastics (Akulon, Stanyl), EMS-Chemie (Grilamid, Grivory, Grilon), Evonik (Vestamid, Trogamid), Radici (Radilon, Radiflam, Raditer, Heraform, Heraflex), Rhodia (Technyl, Stabamid), UBE, DSM (Novamid) and Atofina (Rilsan).

In the examples presented below, a mixture of 12% Durethan B40 FAM (Lanxess), which is a PA 6, and 88% Durethan C38 F (Lanxess), which is a medium-viscosity copolyamide, or a pure PA layer of Durethan C38F (Lanxess) was always used as polyamide layer.

A typically usable adhesive promoter is, for example, Admer NF498E, which is a LDPE made by the Mitsui Co. modified with maleic anhydride groups. Admer AT1955E of the Mitsui Co. was also used. Admer® substances are PE copolymers with maleic anhydride groups (MA groups) that have a strong adhesion to PET, EVOH and PA. At the same time, they can be very well processed and have a thermal stability equivalent to conventional PE.

Polyolefins that can be typically used are, for example, Lupolen 2420 F, a LDPE made by the LyondellBasell Polymers Co., and Exceed 1327 CA made by the ExxonMobil Chemical Company, an ethylene copolymer manufactured by means of metallocen catalysis in whose polymerization hexane is used as additional co-monomer apart from ethylene.

### II. Manufacturing of the Multilayered Films

The multilayered films according to the invention of examples B1, B2, B8, B9 and B10 are 3-layered blown films. The multilayered films according to the invention of examples B3 to B7, B11 consist in each case of five layers. The individual layers of the multilayered films are immediately adjacent to one another in the sequence given below (“layer number”). The tubular films according to the invention were manufactured by means of blown film co-extrusion.

Ethylene (meth)acrylate was used in the multilayered films according to the invention of examples B3, B4 and B6. Lucofin 1494H made by the German company Lucobit AG was used as an ethylene (meth)acrylate, which is a chemically modified polyethylene in form of EBA (ethylene butyl acrylate) grafted with maleic anhydride (MA). In this case, it was used for adhesive promoter layers (layers (d) according to the claims) of multilayered films according to the invention. Lucofin 1400HN Powder, a polar copolymer made of ethylene and butyl acrylate with low crystallinity, was also used. Owing to its chemical structure, Lucofin 1400HN Powder is softer and more flexible than ethylene homopolymers with comparable density. Lucofin 1400HN Powder is supplied without dyes and additives in its natural color. Here, Lucofin 1400HN Powder was used for adhesive promoter layers (i.e. layers (d) according to the claims) and for intermediate layers too. Other usable ethylene (meth)acrylate copolymers were already listed above.

Desmopan DP 2586A (200 series) with a Shore hardness of 86 A (based on method A according to ISO 868) made by BAYER was used as thermoplastic elastomer. Desmopan DP 2586A is a TPU ester. In addition, Pearlthane Clear 15N80, made by MERQUINSA, based on a TPU polyether copolymer and with a Shore hardness of 82 A (according to ASTM D-2240) was used.

The film of comparative example V1 was a commercially available® film with a thickness of 108 μm made by the Valeron Strength Films Co. Valeron films can only be manufactured as flat films. By applying a thin strip with hot melt, the foil was thermally sealed into a tube.

The film of comparative example V2 was a 110 μm thick, one-layered LDPE film in tubular form with a PE melting point of 111° C.

The percentages given in the tables for the individual chemicals in the layers indicate percentages by weight.

### Example 1

### Preliner Film, 3-Layer Blown Film Extrusion, 120 μm

| Layer | | | Amount in | Thickness |
|---|---|---|---|---|
| number | Layer | Composition | the layer in % | in μm |
| 1 | (a) | Durethan C38 F | 88 | 40 |
| | | Durethan B40 FAM | 12 | |
| 2 | (d) | Admer NF498E | 100 | 10 |
| 3 | (b) | Lupolen 2420 F | 70 | 70 |
| | | Exceed 1327 CA | 30 | |
| | | | | Total |
| | | | | thickness |
| | | | | 120 μm |

### Example 2

### Preliner Film, 3-Layer Blown Film Extrusion, 80 μm

| Layer | | | Amount in | Thickness |
|---|---|---|---|---|
| number | Layer | Composition | the layer in % | in μm |
| 1 | (a) | Durethan C38 F | 100 | 20 |
| 2 | (d) | Admer NF498E | 100 | 10 |
| 3 | (b) | Lupolen 2420 F | 70 | 50 |
| | | Exceed 1327 CA | 30 | |
| | | | | Total |
| | | | | thickness |
| | | | | 80 μm |

### Example 3

### Preliner Film, 5-Layer Blown Film Extrusion, 100 μm

| Layer | | | Amount in | Thickness |
|---|---|---|---|---|
| number | Layer | Composition | the layer in % | in μm |
| 1 | (a) | Durethan C38 F | 100 | 20 |
| 2 | (d) | Lucofin 1494 H | 100 | 10 |
| 3 | (b) | Lupolen 2420 F | 70 | 30 |
| | | Exceed 1327 CA | 30 | |
| 4 | (d) | Lucofin 1494 H | 100 | 10 |
| 5 | (b) | Lupolen 2420 F | 70 | 30 |
| | | Exceed 1327 CA | 30 | |
| | | | | Total |
| | | | | thickness |
| | | | | 100 μm |

### Example 4

### Preliner Film, 5-Layer Blown Film Extrusion, 200 μm

| Layer | | | Amount in | Thickness |
|---|---|---|---|---|
| number | Layer | Composition | the layer in % | in μm |
| 1 | (a) | Durethan C38 F | 88 | 40 |
| | | Durethan B40 FAM | 12 | |
| 2 | (d) | Lucofin 1494 H | 100 | 10 |
| 3 | (b) | Lucofin 1400 HN | 50 | 65 |
| | | Lupolen 2420 F | 50 | |
| 4 | (d) | Lucofin 1494 H | 100 | 10 |
| 5 | (b) | Lucofin 1400 HN | 50 | 75 |
| | | Lupolen 2420 F | 50 | |
| | | | | Total |
| | | | | thickness |
| | | | | 200 μm |

### Example 5

### Preliner Film, 5-Layer Blown Film Extrusion, 120 μm

| Layer | | | Amount in | Thickness |
|---|---|---|---|---|
| number | Layer | Composition | the layer in % | in μm |
| 1 | (a) | Durethan C38 F | 100 | 20 |
| 2 | (d) | Admer NF498E | 100 | 10 |
| 3 | (a) | Durethan C38 F | 100 | 20 |
| 4 | (d) | Admer NF498E | 100 | 10 |
| 5 | (b) | Lupolen 2420 F | 70 | 60 |
| | | Exceed 1327 CA | 30 | |
| | | | | Total |
| | | | | thickness |
| | | | | 120 μm |

### Example 6

### Preliner Film, 5-Layer Blown Film Extrusion, 120 μm

| Layer | | | Amount in | Thickness |
|---|---|---|---|---|
| number | Layer | Composition | the layer in % | in μm |
| 1 | (a) | Durethan C38 F | 100 | 40 |
| 2 | (d) | Admer NF498E | 100 | 10 |
| 3 | | Lucofin 1400 HN | 100 | 30 |
| 4 | (d) | Admer NF498E | 100 | 10 |
| 5 | (b) | Lucofin 1400 HN | 50 | 30 |
| | | Lupolen 2420 F | 50 | |
| | | | | Total |
| | | | | thickness |
| | | | | 120 μm |

### Example 7

### Preliner Film, 5-Layer Blown Film Extrusion, 120 μm

| Layer | | | Amount in | Thickness |
|---|---|---|---|---|
| number | Layer | Composition | the layer in % | in μm |
| 1 | (b) | Lupolen 2420 F | 70 | 30 |
| | | Exceed 1327 CA | 30 | |
| 2 | (d) | Admer NF498E | 100 | 10 |
| 3 | (a) | Durethan C38 F | 100 | 40 |
| 4 | (d) | Admer NF498E | 100 | 10 |
| 5 | (b) | Lupolen 2420 F | 70 | 30 |
| | | Exceed 1327 CA | 30 | |
| | | | | Total |
| | | | | thickness |
| | | | | 120 μm |

### Example 8

### Preliner Film, 3-Layer Blown Film Extrusion, 120 μm, Symmetrical

| Layer | | | Amount in | Thickness |
|---|---|---|---|---|
| number | Layer | Composition | the layer in % | in μm |
| 1 | (a) | Durethan C38 F | 100 | 20 |
| 2 | (c) | Desmopan DP 2586A | 100 | 80 |
| 3 | (a) | Durethan C38 F | 100 | 20 |
| | | | | Total |
| | | | | thickness |
| | | | | 120 μm |

### Example 9

### Preliner Film, 3-Layer Blown Film Extrusion, 100 μm

| Layer | | | Amount in | Thickness |
|---|---|---|---|---|
| number | Layer | Composition | the layer in % | in μm |
| 1 | (a) | Durethan C38 F | 100 | 20 |
| 2 | (c) | Desmopan DP 2586A | 100 | 40 |
| 3 | (c) | Desmopan DP 2586A | 97 | 40 |
| | | Separator/Anti- | 3 | |
| | | blocking agent | | |
| | | | | Total |
| | | | | thickness |
| | | | | 100 μm |

### Example 10

### Preliner Film, 3-Layer Blown Film Extrusion, 120 μm, Symmetrical

| Layer | | | Amount in | Thickness |
|---|---|---|---|---|
| number | Layer | Composition | the layer in % | in μm |
| 1 | (a) | Durethan C38 F | 100 | 20 |
| 2 | (c) | Pearlthane Clear | 100 | 80 |
| | | 15N80 | | |
| 3 | (a) | Durethan C38 F | 100 | 20 |
| | | | | Total |
| | | | | thickness |
| | | | | 120 μm |

### Example 11

### Preliner Film, 5-Layer Blown Film Extrusion, 140 μm, Asymmetrical

| Layer | | | Amount in | Thickness |
|---|---|---|---|---|
| number | Layer | Composition | the layer in % | in μm |
| 1 | (b) | Lupolen 2420 F | 70 | 30 |
| | | Exceed 1327 CA | 30 | |
| 2 | (b) | Lupolen 2420 F | 70 | 30 |
| | | Exceed 1327 CA | 30 | |
| 3 | (d) | Admer AT1955E | 100 | 10 |
| 4 | (c) | Pearlthane 16N85 UV | 100 | 30 |
| 5 | (a) | Durethan C38 F | 100 | 40 |
| | | | | Total |
| | | | | thickness |
| | | | | 140 μm |

### Testing Methods and Instruments

Blow-up tests were carried out for determining the elasticity of the two films of comparative examples V1 and V2 as well of the various multilayered films according to the invention in form of tubular films (B1 to B11). If a multilayered film to be tested is not a tubular film but a flat film, for example, it is sealed to become a hose to determine its elasticity afterwards. The tests that are part of the invention were done on tubular films.

In preparation, both ends of (a 5 m long hose or) a 5 m long tubular film having a hose diameter of 1175 mm to 1180 mm were hermetically sealed by two metal disks that had a suitable diameter. As is customary with such blow-up tests, lashing straps and commercially available fabric adhesive tape were used to achieve airtightness. Through a valve in one of the two metal disks, pressurized air was introduced into the tubular film until it burst but before this occurred, tears in the layers of the internal film layers could be recognized. These tears receive the name of splice. From them, a strictly localized bubble formed in the multilayered film, which subsequently led to a film tear and the bursting of the tubular film as blowing continued. The maximum elongation (expressed in percent) was determined by measuring the maximum external circumference of the tubular film achieved until it burst and comparing it with the initial tube diameter. The following formula was used:

Maximum elongation at break=[(tube diameter after blowing/initial tube diameter before blowing)−1]·100

The same formula is used for the “film splice”, i.e. the first recognizable tear of a tubular film's layer (without affecting the entire tube):

“Splice”=[(tube diameter after blowing and first recognizable layer tear/initial tube diameter before blowing)−1]·100

For the other tests, the films were stored 24 hours under normal climate conditions.

A universal testing machine 281813 made by the Frank Co. was used as test instrument for the stretching tests (tensile properties, Young's modulus, etc.) and the tear propagation tests. The force of the load cell was 200 N, testing speed was 300 mm/min and 15 mm wide strips were used for the stretching test.

The testing instrument used for the sliding friction was the BETEX Slipping Tester RK2 with a load cell of 10 N. A LINSEIS L120 E recorder was used. Two film pieces were loaded with a weight (1.96 N), pulled above one another and the force needed for this measured.

The testing instrument used for measuring the sealing seam strength was once again the universal testing machine 281813 made by the Frank Co. with a load cell of 200 N. Testing speed was set at 100 mm/min. 15 mm wide strips were sealed using the laboratory sealing instrument SGPE 20 made by the Kopp Co. with a sealing jaw width of 10 mm flat. Sealing time was 1 sec, sealing temperature 130° C. and sealing pressure 300 N/m².

### Measurement Results

### I. Elongation at Break

The following table summarizes the result of the blow-up test:

| Example/ | | |
|---|---|---|
| Comparative | | Elongation [%] until |
| example | Splice [%] | bursting |
| B1 | 17.3 | 90.5 |
| B2 | 16.5 | 87.9 |
| B3 | 30.5 | 131.5 |
| B4 | 25.6 | 133.5 |
| B5 | 16.9 | 92.7 |
| B6 | 31.2 | 132.1 |
| B7 | 15.6 | 82.0 |
| B8 | 29.3 | 135.2 |
| B9 | 36.4 | 138.3 |
| B10 | 31.2 | 139.9 |
| B11 | 27.5 | 126.6 |
| V1 | 5.9 | 25.2 |
| V2 | — | 45.7 |

The blow-up tests for determining the elongation at break show that the film from comparative example V1 stretched only very little (5.9%) until it spliced or 25.2% until the film burst. This demonstrated that the use of this film as preliner for the tube lining process in trenchless sewage pipe renovation or as inner tube film in pipe liners is hardly suited at all. Although the mechanical properties of the film from comparative example 1 are very good with regard to tear propagation strength and puncture resistance, they are accompanied by poor elasticity and therefore these films are only suited to a limited extent for trenchless sewage pipe renovation.

The film from comparative example V2, a LDPE mono film in tubular form, showed no splice strictly speaking, as there was only one layer. This layer burst when it was stretched 45.7% and showed that the mechanical properties were completely insufficient and only very little resistance could counter the pressurized air applied. This film hardly has any mechanical strength and can be torn without a problem. Therefore, this film is unsuitable for use as preliner or inner tube film.

On the other hand, the films according to the invention from examples B1 to B11 did not only have very good tear propagation strength and puncture resistance values (even if the corresponding values for the film from comparative example V1 were not reached) but could be stretched a good deal until the film spliced or burst. Thus, an elongation until splice of more than 15% was obtained for all films from examples B1 to B11; in some of them, even values significantly higher than 30% were reached (examples B3 and B6, in particular B9 and B10). These advantageous properties are explained especially by the fact that films B1 to B11 have at least one layer containing polyamide and also one layer with some polyolefin and/or one layer with a thermoplastic elastomer TPE.

If a polyolefin is used in a layer and it is additionally mixed with an ethylene (meth)acrylate copolymer or replaced by it, particularly high values for the elongation at break are obtained (examples B3, B4 & B6). The use of TPE (in this case a thermoplastic polyurethane TPU) made of soft ester or ether segments in one or several layers (examples B8 to B11) has the same effect (namely, extremely high elongation values until the film splices or bursts).

In the films according to the invention from examples B1 to B11, the elongation until the film breaks or bursts is more than 80%, in some cases even significantly more than 100% (top value: 139.9% in example B10).

The use according to the invention of polyamide ensures not only the films' higher mechanical strength (e.g. tear and tear propagation resistance) but also creates a barrier against oils and monomers from the resins with which the carrier material was impregnated during the pipe lining process. This protects the resin from drying out.

The following table lists the measurement results for the elasticity modulus (also known as e-modulus, tensile modulus, elasticity coefficient or Young's modulus). The elasticity modulus describes the relationship between tension and elongation during the deformation of a solid body in linear elastic behavior.

| Example/ | Elasticity modulus in | Elasticity modulus in |
|---|---|---|
| Comparative | N/mm² | N/mm² |
| example | md (machine direction) | cd (cross direction) |
| B1 | 190 | 196 |
| B2 | 137 | 141 |
| B3 | 125 | 126 |
| B4 | 153 | 154 |
| B5 | 149 | 151 |
| B6 | 115 | 119 |
| B7 | 150 | 155 |
| B8 | 71 | 73 |
| B9 | 59 | 59 |
| B10 | 28 | 29 |
| B11 | 105 | 106 |
| V1 | 296 | 307 |
| V2 | 110 | 115 |

The e-modulus of a film indicates how stiff or flexible it is. The bigger the e-modulus of a film, the stiffer it is. The high stiffness or associated lower flexibility is coupled with a clearly lower capacity of the film to allow being turned inside out. Yet this turning inside out is precisely very high in demand in a film when the intention is to use it as preliner in trenchless sewage pipe renovation, i.e. when the preliner is inverted inside the pipe with the pipe liner or when the preliner is already invaginated beforehand.

The films according to the invention from examples B1 to B7 have low values for Young's modulus, in the range between 115 and 196 N/mm² in and or cd direction. Lower values for Young's modulus are found in the films according to the invention from examples B2 (with copolyamide Durethan C38 F as polyamide, Young's modulus: approx. 140 N/mm²), B3 (with Lucofin 1494 H made from ethylene acrylate in the adhesive promoter layer and copolyamide as polyamide, Young's modulus: approx. 125 N/mm²), B5 (two layers with copolyamide Durethan C38 F, Young's modulus: approx. 150 N/mm²), B6 (use of ethylene acrylate copolymers, also in a mixture with the polyolefin polyethylene, especially low Young's modulus of approx. 117 N/mm²), as well as B7 (medium layer copolyamide Durethan C38 F, Young's modulus: approx. 152 N/mm²).

If the copolyamide Durethan C38 F is mixed with the somewhat stiffer PA 6 homopolyamide (see examples B1 and B4—here an 88% mixture of co-polyamide Durethan C38 F with 12% of PA 6 Durethan B40 FAM), this leads to essentially higher elasticity moduli in the films.

The clearest reduction of elasticity moduli is achieved when thermoplastic elastomers (TPE) are used. In the film of example B8, which has an ester-based TPU layer, the elasticity modulus is approx. 72 N/mm².

The elasticity modulus can be reduced even more—as expected—by increasing the proportion of TPU in the overall film, as can be seen in example B9 (here, Young's modulus is 59 N/mm²).

If a polyether-based TPU is used (example B10), we get an elasticity modulus of only 29 N/mm² and with it, compared to the structurally identical film from example B8 (here with a polyester-based TPU) a reduction of the elasticity modulus by 43 N/mm².

Example B11 is a film consisting of polyolefin, adhesive promoter, TPU (polyether-based) and polyamide. The approximate value of the elasticity modulus of 105 N/mm² is comparable to pure LDPE (see comparative example V2 approx. 112 N/mm²) and low. In this way, the basic increase of Young's modulus, which takes place by the layer containing polyamide in the films according to the invention, can be counteracted by incorporating TPE as extra material in an additional layer.

On the other hand, the product from comparative example V1 used so far as preliner has a much higher elasticity modulus. Compared to the films according to the invention from examples B1 to B11, Young's modulus is about 1.5 to almost 10 times higher in the 108 μm thick Valeron film. Thus, the film from comparative example V1 cannot be easily inverted or turned inside out at all compared to the films according to the invention from examples B1 to B11.

### II. Friction

The table below lists the results from the friction properties, whose determination is a basic property of films and packaging. The coefficient of friction (adhesive friction/sliding friction) was determined according to DIN EN ISO 8295 and is also known as adhesive friction number or sliding friction number. Furthermore, the surface of the friction partners should be considered to establish whether it makes sense to perform a friction test of metal against film surface or film surface against film surface. The friction number is a ratio from friction force and bearing force of the slide and therefore has no dimensions. Owing to the standardized slide weight of 200 g, the actual friction force is about twice as large as the friction number.

| Example/ | Sliding friction | Sliding friction | |
|---|---|---|---|
| Comparative | Side 1 against | Side 2 against | |
| example | side 1 (material) | side 2 (material) | Film structure |
| B1 | 0.23 (PA) | 0.21 (PE) | asymmetrical |
| B2 | 0.20 (PA) | 0.16 (PE) | asymmetrical |
| B3 | 0.19 (PA) | 0.12 (PE) | asymmetrical |
| B4 | 0.25 (PA) | 0.09 (PE) | asymmetrical |
| B5 | 0.29 (PA) | 0.17 (PE) | asymmetrical |
| B6 | 0.24 (PA) | 0.23 (PE) | asymmetrical |
| B7 | 0.08 (PE) | 0.10 (PE) | symmetrical |
| B8 | 0.22 (PA) | 0.21 (PA) | symmetrical |
| B9 | 0.19 (PA) | 0.28 (TPU ester) | asymmetrical |
| B10 | 0.20 (PA) | 0.22 (PA) | symmetrical |
| B11 | 0.11 (PE) | 0.22 (PA) | asymmetrical |
| V1 | 0.29 (HDPE) | 0.33 (HDPE) | symmetrical |
| V2 | 0.12 (LDPE) | 0.11 (LDPE) | symmetrical |

Films with a low coefficient of friction are necessary for use as preliners. Owing to their low coefficient of friction, the films according to the invention from examples B1 to B11 are especially good for use as preliners in the pipe lining process for trenchless sewage pipe renovation.

As can be seen in the detail shown in the table, the films according to the invention from examples B1 to B11 can be adjusted in such a way that their coefficients of friction are especially low. In examples B1 to B11, a range from about 0.05 to about 0.29 has been achieved. The film from comparative example V1, on the other hand, whose average coefficient of friction is 0.31, has a higher value. The film from comparative example V2 has a lower coefficient of friction of 0.12 and in this respect would also be suitable as preliner or sliding film for use in the pipe lining process.

The expert knows very well that many additives can be used to lower the coefficient of friction even more. However, their effect in comparative example V1 is very limited owing to this film's manufacturing process.

### III. Sealing Seam Strength

Comparative film V1 is available only as flat film and must be sealed to become tubular, in which case 3.2 to 10.5 N/15 mm sealing seam strength must be reached. In the sealing conditions mentioned above, the film from comparative example V1 consequently has only poor sealing capacity. Since owing to its manufacturing it's only available as flat film, it is welded with hot melt adhesives for its required use as tubular film. The sealing capacity of this comparative film V1 is too low to ensure a high-strength sealing seam in the resulting hose. The use of hot melt adhesives for general sealing is very critical here too, as there is basically a problem of adherence between the hot melt adhesive and the film. In preliners or inner tube films, high sealing seam strength is especially important to prevent the penetration of water (preliner) or evaporation of resin (inner tube film). In this regard, it is very risky to use the film from comparative example V1.

Owing to what has been said above, it is generally recommended to use a hose obtained through extrusion because then it won't have a weak point in the form of a sealing seam. The films according to the invention preferably have no sealing seam and as a result of that these films no longer have a “weak point”. The film tubes of the films according to the invention from examples B1 to B11 are consequently fully homogeneous and capable of resisting the highest stresses. Maximum barrier function against water or monomers from the resins is guaranteed.

In the comparative film V2 in tubular form, sealing seam strength was above 30 N/15 mm; owing to the tubular form, however, a sealing to obtain a tube is basically unnecessary. Yet even if the film is available as flat film, the film from V2 can be easily sealed or welded to a tube.

If the films according to the invention B1 to B7 and B11, available preferably as flat films, are first manufactured as flat films, their polyolefin side is preferably sealed. In these example films B1 to B7 and B11, sealing seam strength, as in comparative film V2, was also considerably higher than 30 N/15 mm, making these films fully sturdy and impermeable.

In the films from examples B8 to B10, on the other hand, sealing capacity is reduced because they have no polyolefin external layer. The use of hot melt adhesives is not necessary, however, as the films according to the invention from examples B1 to B8 and B10 to B11 can be ideally sealed on their polyolefin side.

### Summary of the Measurement Results

The following table finally shows the advantages of the films according to the invention from examples B1 to B11 with the film from comparative example V1 used to date in the state of the art with regard to the properties relevant for use.

| | Property- relevant for use as preliner/inner tube film | | | | | | | |
|---|---|---|---|---|---|---|---|---|
| | | | | | | | Flexi- | |
| | | | | | | | bility, | |
| | | | Barrier, | | | | turning | |
| | Tubular | Sealing | imperme- | | | Elas- | inside | |
| Name | form | capacity | ability | WRF | PR | ticity | out | COF |
| B1 | ++ | ++ | ++ | + | + | + | 0/+ | 0/+ |
| B2 | ++ | ++ | ++ | + | + | + | + | 0/+ |
| B3 | ++ | ++ | ++ | + | + | ++ | ++ | 0/+ |
| B4 | ++ | ++ | ++ | + | + | ++ | + | 0/+ |
| B5 | ++ | ++ | ++ | + | + | + | + | 0 |
| B6 | ++ | ++ | ++ | + | + | ++ | ++ | 0/+ |
| B7 | ++ | ++ | ++ | + | + | + | + | + |
| B8 | ++ | 0/+ | ++ | + | + | ++ | ++ | 0/+ |
| B9 | ++ | 0/+ | ++ | + | + | ++ | ++ | 0/+ |
| B10 | ++ | 0/+ | ++ | + | + | ++ | ++ | 0/+ |
| B11 | ++ | ++ | ++ | + | + | ++ | ++ | 0/+ |
| V1 | 0 | − | −/0 | ++ | ++ | − | 0 | 0 |
| V2 | ++ | ++ | − | − | − | −/0 | ++ | 0/+ |

Legend:
−: insufficient values
0: sufficient for the application
+: quite suitable for the application
++: very suitable for the application
WRF: tear propagation strength
PR: puncture resistance
COF: coefficient of friction

It follows from the table that the properties of the films according to the invention from examples B1 to B11 are greatly emphasized compared to those of the films from comparative examples V1 and V2 with regard to their suitability as preliner, water protection film, sliding film, calibration film or inner tube film as part of the pipe lining process in trenchless sewage pipe renovation. Thus, the films according to the invention constitute a clear improvement compared to the current state of the art. The multilayered film according to the invention is also ideally suited even for the other applications mentioned here.

What is claimed is:

1. An insertion tube for trenchless sewer pipe renovation using a pipe lining process, said insertion tube comprising:
an inner tube film in the form of a multilayer tubular film,
an external tubular film, and
a carrier material between the inner tube film and the external tubular film, the carrier material impregnated with a reactive plastic resin that forms a renovated inner sewer pipe after curing; and
wherein the inner tube film comprises:
at least one layer (a) comprising at least a homo- or copolyamide having a proportional weight expressed in percent of more than 25% by weight; and
a layer (c) containing at least one thermoplastic elastomer (TPE).

2. The insertion tube according to claim 1, wherein the layer (a) contains more than 75% by weight of thermoplastic homo- or copolyamides.

3. The insertion tube according to claim 1, wherein the layer (a) contains up to 100% by weight of thermoplastic homo- or copolyamides.

4. The insertion tube according to claim 1, wherein the inner tube film comprises a further layer (b) that contains a thermoplastic olefin homo- or copolymer.

5. The insertion tube according to claim 4, wherein the layer (b) contains more than 20% by weight of the thermoplastic olefin homo- or copolymer.

6. The insertion tube according to claim 4, wherein the layer (b) contains up to 100% by weight of the thermoplastic olefin homo- or copolymer.

7. The insertion tube according to claim 1, wherein the layer (c) contains more than 20% by weight of the thermoplastic elastomer (TPE).

8. The insertion tube according to claim 1, wherein the layer (c) contains up to 100% by weight of the thermoplastic elastomer (TPE).

9. The insertion tube according to claim 1, wherein the thermoplastic elastomer (TPE) in the layer (c) is selected from the following group:
a) TPE-U or TPU (thermoplastic elastomers made of urethane);
b) TPE-O or TPO (thermoplastic elastomers made of olefin, primarily PP/EPDM);
c) TPE-V or TPV (cross-linked thermoplastic elastomers made of olefin, primarily PP/EPDM);
d) TPE-E or TPC (thermoplastic polyester elastomers/thermoplastic copolyesters);
e) TPE-S or TPS (styrene block copolymers (SBS, SEBS, SEPS, SEEPS and MBS));
f) TPE-A or TPA (thermoplastic copolyamides); and
g) TPE silicon.

10. The insertion tube according to claim 1, wherein the inner tube film further comprises an additional layer (d), wherein layer (d) is an adhesive promoter layer containing an olefin homo- or copolymer, and wherein layer (d) is arranged according to one of:
between two of layers (a);
wherein the inner tube film comprises at least a further layer (b), which contains a thermoplastic olefin homo- or copolymer, and layer (d) is between one layer (a) and one layer (b);
wherein the inner tube film comprises at least two further layers (b), which contain a thermoplastic olefin homo- or copolymer, and layer (d) is between the two layers (b);
between one layer (a) and one layer (c);
wherein the inner tube film comprises at least a further layer (b), which contains a thermoplastic olefin homo- or copolymer, and layer (d) is between one layer (b) and one layer (c); or
between two of layers (c).

11. The insertion tube according to claim 1, wherein the inner tube film has two external layers, at least one of the external layers comprising layer (a).

12. The insertion tube according to claim 1, wherein the inner tube film has a thickness of 20 to 2000 μm.

13. The insertion tube according to claim 1, wherein the inner tube film has a thickness of 80 to 250 μm.

14. The insertion tube according to claim 1, wherein the inner tube film further comprises one of:
a further layer (b) that contains a thermoplastic olefin homo- or copolymer; or
a further layer (d) that is an adhesive promoter layer containing an olefin homo- or copolymer, and
wherein at least one of the layers (b) or (d) contains an ethylene (meth)acrylate copolymer in functionalized or non-functionalized form, in which case the proportional weight expressed in percent of the ethylene (meth)acrylate copolymer is in the range from 0.1 to 100% by weight.

15. The insertion tube according to claim 14, wherein the proportional weight expressed in percent of the ethylene (meth)acrylate copolymer is at least 30% by weight.

16. The insertion tube according to claim 1, wherein the inner tube film further comprises one of:
a further layer (b) that contains a thermoplastic olefin homo- or copolymer; or
a further layer (d) that is an adhesive promoter layer containing an olefin homo- or copolymer;
wherein any one or combination of the following substances are contained in at least one of the layers (a), (b):
polystyrene (PS); polyhalogenides, including PVC or polyvinylidene chloride (PVdC); ethylene vinyl alcohol copolymer (EVOH); polyvinyl alcohol (PVOH or PVAL); adhesive promoter; ethylene vinyl acetate (EVAc); one or several ionomers; one or several poly(meth)acrylates; poly(meth)acrylates containing ethylene; polyvinyl acetate (PVAc); polycarbonate (PC); polyacryl nitrile (PAN); additional polyesters including polybutylene terephthalate (PBT), polyethylene naphthalate (PEN), polylactic acid (PLA) or polyhydroxyalkanoate (PHA); one or several ethylene acrylic acid copolymers (EAA); polyvinyl butyral (PVB); polyvinyl acetal; cellulose acetate (CA); cellulose aceto butyrate (CAB); polysaccharides; starch; cyclic olefin copolymer (COC).

17. The insertion tube according to claim 1, wherein the inner tube film further comprises one of:
a further layer (b) that contains a thermoplastic olefin homo- or copolymer; or
a further layer (d) that is an adhesive promoter layer containing an olefin homo- or copolymer; and
wherein any one or combination of the following substances are added during extrusion to at least one of the layers (a), (b), (c), or (d):
adhesive promoters, functionalized polymers including EVOH, optical brighteners, thermal stabilizers, lubricants, antioxidants, oxygen scavengers, separators including silica particles or SAS), slip/anti-blocking agents, dyes, pigments, foaming agents, antistatic agents, process aids, lubricating agents, flame retardants, flame suppressors, impact modifiers, impact resistance improvers, anti-hydrolysis agents, UV absorbers, UV protection agents, stabilizers, anti-fog additives, waxes, wax additives, release agents, sealing or peeling additives, nucleation agents, compatibilizers, flow agents, flow improvers, melt strength enhancers, molecular weight enhancers, cross-linking agents or softeners.

18. The insertion tube according to claim 1, wherein the inner tube film is laminated on one of its external layers with a non-woven material, fabric, needle felt, synthetic fibers, or fleece.

19. The insertion tube according to claim 1, wherein the external tubular film absorbs or reflects UV radiation.

20. A method for renovation of a trenchless sewer pipe, the method comprising inserting the insertion tube of claim 7 into the sewer pipe and using an energy source to cure the reactive plastic resin impregnated in the carrier material to form a renovated inner sewer pipe.
